(19) United States
(12) Patent Application Publication
(10) Pub. No.: US 2013/0297851 A1
(43) Pub. Date: Nov. 7, 2013

(54) PERIPHERAL DEVICE AND DATA ACCESS CONTROL METHOD THEREOF

(71) Applicant: Chung-Wen Huang, New Taipei City (TW)

(72) Inventor: Chung-Wen Huang, New Taipei City (TW)

(21) Appl. No.: 13/461,804

(22) Filed: May 2, 2012

(51) Int. Cl. G06F 12/00

(52) U.S. Cl. 711/103; 711/154; 711/E12.008

(57) ABSTRACT

A peripheral device includes a first memory, a second memory, a first access controller, a second access controller and a main controller. When accessing data, first data is written to the first memory from the main controller while second data is read from the second memory to the main controller. Then the first data is written from the first memory to the second memory after writing the first data to the first memory and reading the second data from the second memory are completed.

### BACKGROUND

1. Technical Field

The present invention relates to a peripheral device and a data access control method thereof, more particularly, a peripheral device and a data access control method for improving data transfer rate.

2. Description of the Conventional Art

As larger and larger data and files are required to be transferred between peripheral devices, data transfer rate is getting more and more crucial to communication interfaces and peripheral devices.

Communication interfaces such as USB 3.0, Light Peak, SATA, etc., now all support high speed full duplex mode in which writing data to and reading data from the peripheral device can be performed simultaneously so as to increase data transfer rate between peripheral devices.

However, peripheral devices available in market are working at half duplex mode in which writing data to and reading data from the peripheral device are performed alternatively at different time. Please refer to FIG. 1 illustrating a prior art timing diagram of writing and reading cycles. Writing data to and reading data from the peripheral device are performed alternatively and can not be performed simultaneously.

Therefore, the data transfer rate of peripheral devices working at half duplex mode is limited by not being able to write and read data at the same time. Utilizing high speed bandwidth channel and transferring data with high speed through full duplex mode of communication interfaces are unattainable.

### SUMMARY

An embodiment of the present invention discloses a peripheral device. The peripheral device comprises a first memory, a first access controller, a second memory, a second access controller, a switch and address controller, and a main controller. The first access controller is coupled to the first memory for accessing the first memory. The second access controller is coupled to the second memory for accessing the second memory. The switch and address controller is coupled to the first access controller and the second access controller for switching the first access controller and the second access controller and recording addresses of data stored in the first memory and the second memory. The main controller is coupled to the switch and address controller. The main controller comprises a first core coupled to the first access controller for controlling data access of the first access controller and a second core coupled to the second access controller for controlling data access of the second access controller.

Another embodiment of the present invention discloses a method for controlling data access of a peripheral device. The peripheral device comprises a first memory and a second memory both storing identical existing data, and a main controller. The method comprises writing first data to the first memory from the main controller, reading the existing data from the second memory to the main controller when writing the first data to the first memory, reading the first data from the first memory by a first access controller coupled to the main controller and the first memory, and writing the first data to the second memory by a second access controller coupled to the main controller and the second memory.

Another embodiment of the present invention discloses a method for controlling data access of a peripheral device. The peripheral device comprises a first memory and a second memory both storing identical existing data, and a main controller. The method comprises writing first data to the first memory from the main controller, reading the first data and/or the existing data from the first memory to the main controller, writing second data to the second memory from the main controller when reading the first data and/or the existing data from the first memory, reading the first data from the first memory by a first access controller, writing the first data to the second memory by a second access controller, reading the second data from the second memory by the second access controller, and writing the second data to the first memory by the first access controller.

Another embodiment of the present invention discloses a method for controlling data access of a peripheral device. The peripheral device comprises a memory storing existing data, a bootstrap memory and a main controller. The method comprises checking whether the existing data is being read by the main controller, writing data to the bootstrap memory if the existing data is being read by the main controller, writing the data to the memory if the existing data is not being read by the main controller.

Another embodiment of the present invention discloses a method for controlling data access of a peripheral device. The method comprises reading existing data in a first memory of the peripheral device, writing first data to a second memory of the peripheral device when reading the existing data in the first memory, reading the first data from the second memory, writing second data to the first memory when reading the first data in the second memory, and synchronizing the first data and the second data in the first memory and the second memory after reading the first data from the second memory and writing the second data to the first memory are completed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a prior art timing diagram of writing and reading cycles.

FIGS. 2A-2C are block diagrams illustrating main structures of a peripheral device according to an embodiment of the present invention.

FIG. 3 is a flowchart illustrating a method for controlling data access of the peripheral device in FIG. 2A according to an embodiment of the present invention.

FIGS. 4A-4C are block diagrams illustrating data access of the peripheral device in FIG. 2A according to the flowchart in FIG. 3 of the present invention.

FIG. 4D illustrates a timing diagram according to an embodiment of the present invention.

FIGS. 5A, 5B are flowcharts illustrating methods for controlling data access of the peripheral device in FIG. 2A according to other embodiments of the present invention.

FIGS. 6A-6C are block diagrams illustrating data access of the peripheral device in FIG. 2A according to the flowcharts in FIGS. 5A, 5B of the present invention.

FIG. 7 is a flowchart illustrating a method for controlling data access of the peripheral device in FIG. 2A according to another embodiment of the present invention.

FIGS. 8A-8C and FIGS. 9A-9C are block diagrams illustrating data access of the peripheral device in FIG. 2A according to the flowchart in FIG. 7 of the present invention.

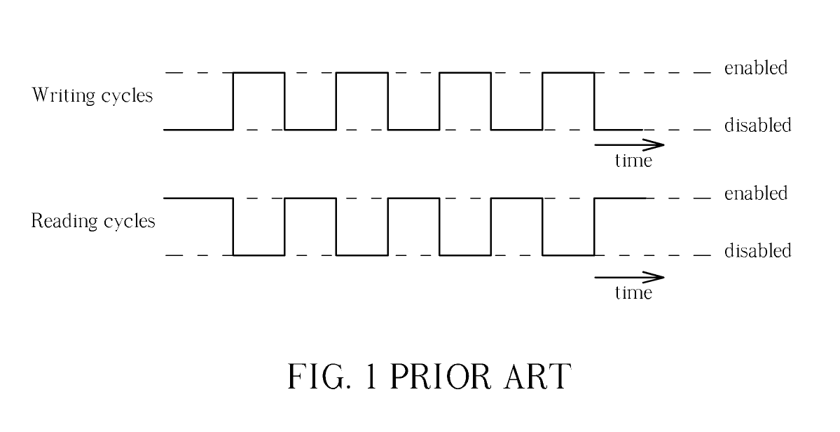

### DETAILED DESCRIPTION

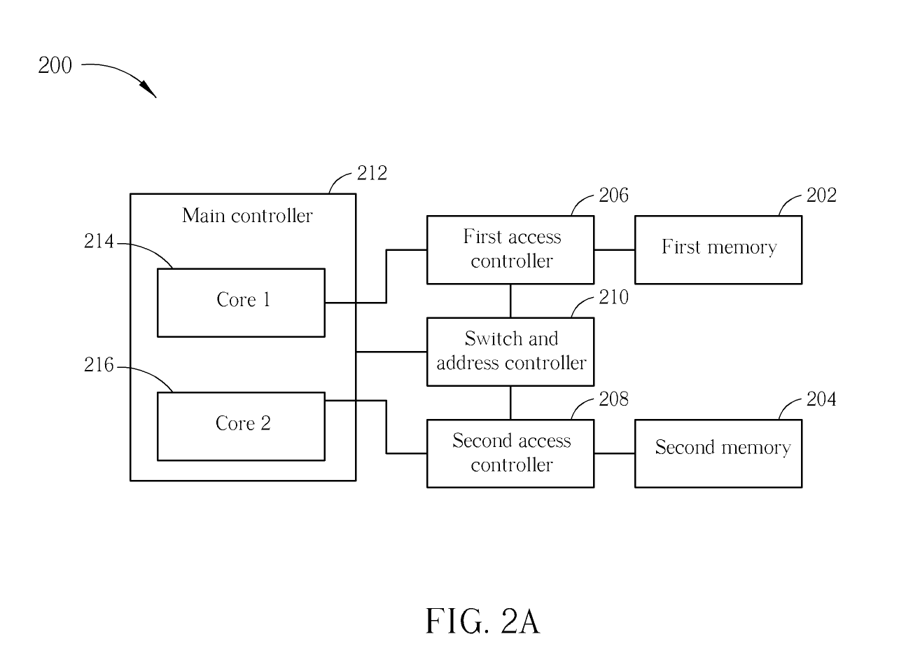

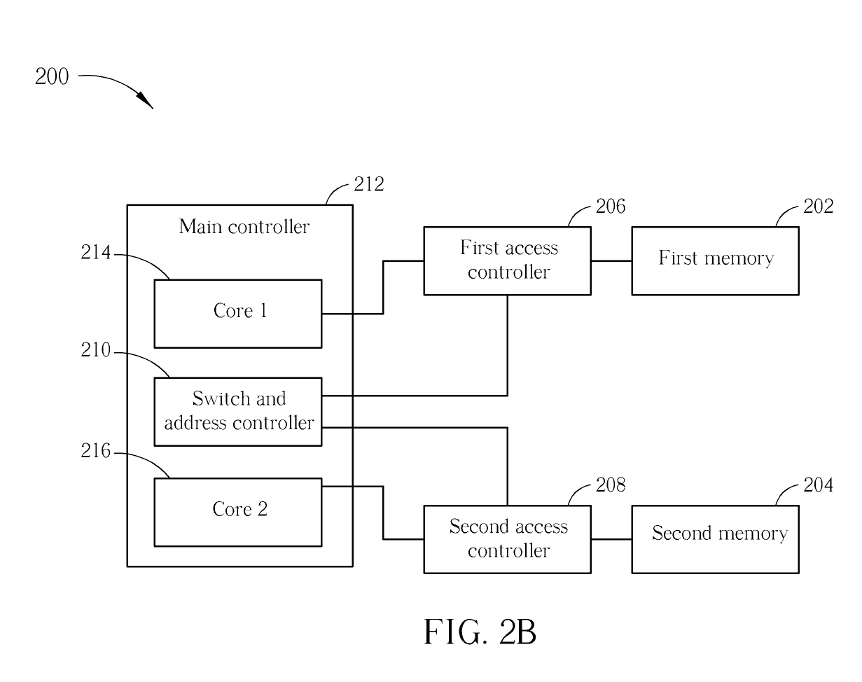

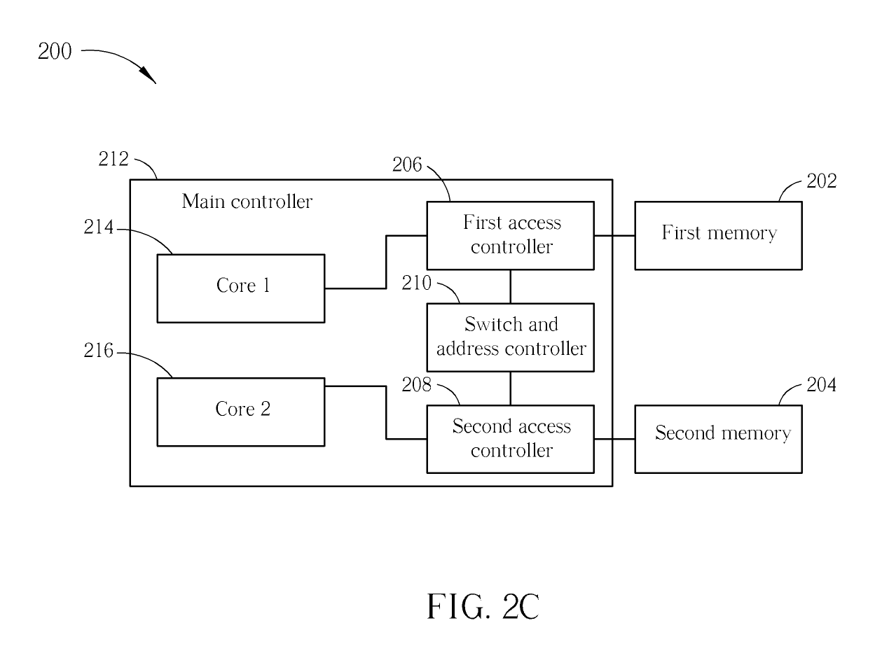

FIG. 2A is a block diagram illustrating a main structure of a peripheral device 200 according to an embodiment of the present invention. The peripheral device 200 comprises a first memory 202, a first access controller 206, a second memory 204, a second access controller 208, a switch and address controller 210, and a main controller 212. The first access controller 206 is coupled to the first memory 202 for accessing the first memory 202. The second access controller 208 is coupled to the second memory 204 for accessing the second memory 204. The switch and address controller 210 is coupled to the first access controller 206 and the second access controller 208 for controlling and switching the first access controller 206 and the second access controller 208, and recording addresses of data stored in the first memory 202 and the second memory 204. The recorded address in the switch and address controller 210 can be a form of a table to record data address of the first memory 202 and the second memory 204. The main controller 212 is coupled to the switch and address controller 210. The main controller 212 further comprises a first core 214 coupled to the first access controller 206 for controlling data access of the first access controller 206, and a second core 216 coupled to the second access controller 208 for controlling data access of the second access controller 208. When the main controller 212 provides a data accessing command, the switch and address controller 210 may depend on the status of the first access controller 206 and the second access controller 208 to decide which of the access controllers to proceed the command, then pass the command to the proper access controller or feedback to the main controller. This will be described more detail later. In another embodiment of the present invention, the switch and address controller 210 is integrated into the main controller, as shown in FIG. 2B. Yet in another embodiment of the present invention, the main controller 212 (comprising the first core 214 and second core 216), the first access controller 206, the second access controller 208, and the switch and address controller 210 can be integrated into a single controller unit, as shown in FIG. 2C. The first and second memory, 202, 204 can both be non-volatile memories. The second memory 204 can be a bootstrap memory. The so called “bootstrap memory” in the present invention can be used or defined as a buffer or backup memory for writing data, and will be described more detail later.

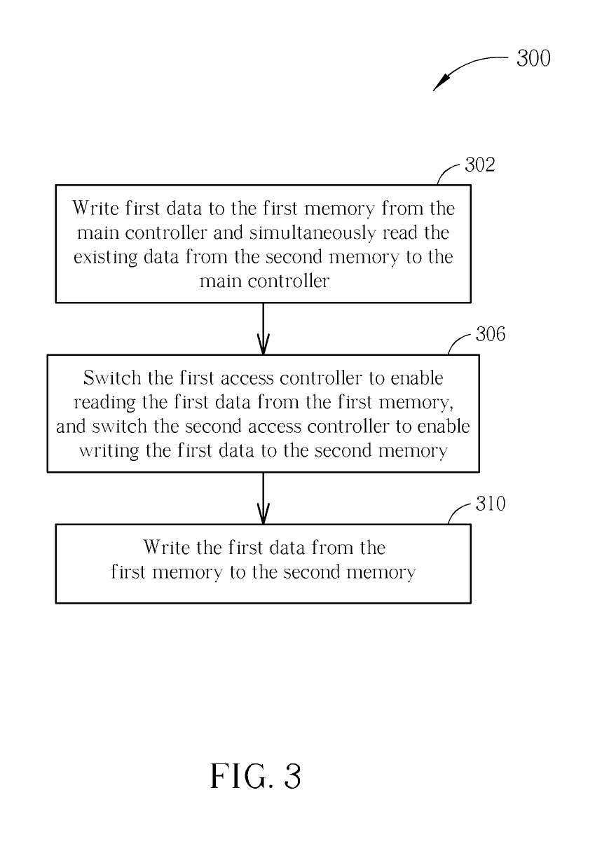

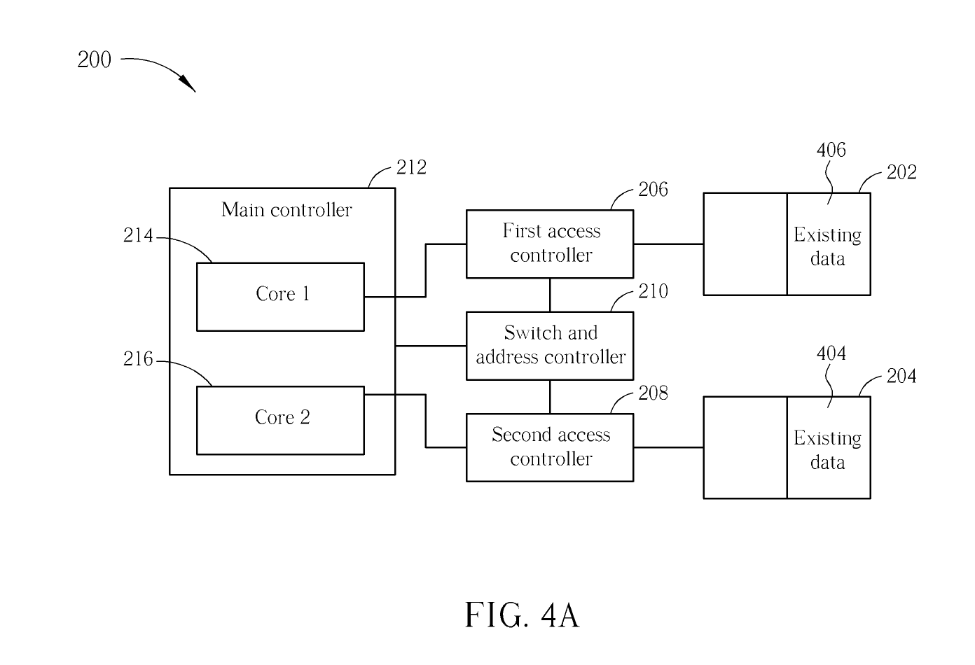

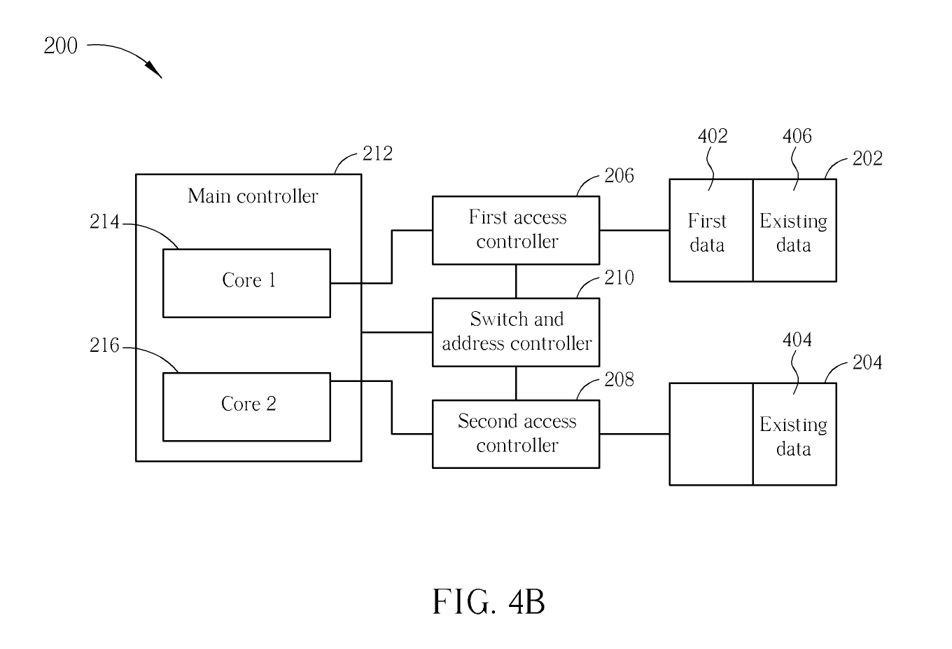

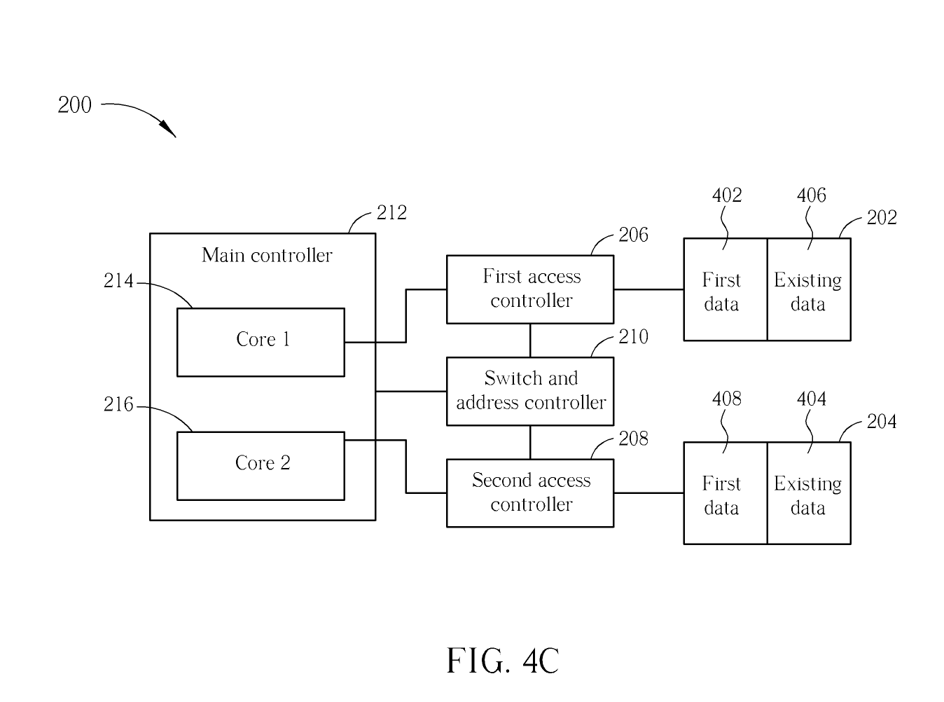

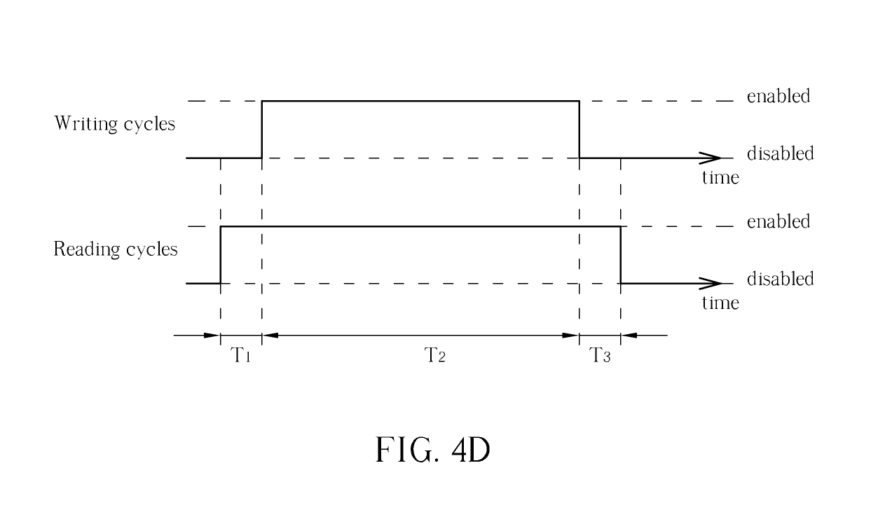

Please refer to FIG. 3, 4A, 4B and 4C. FIG. 3 is a flow chart illustrating a method 300 for controlling data access of the peripheral device 200 according to an embodiment of the present invention. FIG. 4A is a preliminary status of the peripheral device 200 in the method 300. The peripheral device 200 includes existing data 406 in the first memory 202 and existing data 404 in the second memory 204. The existing data 406 and the existing data 404 are identical. The method 300 is illustrated as follows:

Step 302: write first data 402 to the first memory 202 from the main controller 212 and simultaneously read the existing data 404 from the second memory 204 to the main controller 212;

Step 306: switch the first access controller 206 to enable reading the first data 402 from the first memory 202, and switch the second access controller 208 to enable writing the first data 402 to the second memory 204;

Step 310: write the first data 402 from the first memory 202 to the second memory 204.

The first access controller 206 and the second access controller 208 can be switched to enable reading data to the main controller 212, or writing data to the first memory 202 and the second memory 204 by the switch and address controller 210. And the switching process can be performed before step 302 or in step 306.

In step 310, the switch and address controller 210 can be switched to enable passing the first data 402 through the switch and address controller 210 so that writing the first data 402 from the first memory 202 to the second memory 204 can be through the first access controller 206, the switch and address controller 210, and the second access controller 208. In another embodiment, the main controller 212 can be switched to enable passing the first data 402 through the main controller 212 so that writing the first data 402 from the first memory 202 to the second memory 204 can be through the first access controller 206, the main controller 212, and the second access controller 208.

Please refer to FIG. 4C, the first data 402 from the first memory 202 is written to the second memory 204 as in step 310 to clone and backup the first data 402 in the first memory 202 to the second memory 204 as the first data 408. As a result, the first data 402 in the first memory 202 and the first data 408 in the second memory 204 are identical. Because in half duplex mode, writing data to and reading data from a peripheral device are performed alternatively at different time, by storing identical data in both the first memory 202 and the second memory 204 as described in step 310, the existing data 404 in the second memory 204 can be read while writing the first data 402 to the first memory 202 as described in step 304. In so doing, writing and reading of the peripheral device 200 can be performed simultaneously so as to work in full duplex mode to improve data transfer rate.

Please refer to FIG. 4D, FIG. 4D illustrates a timing diagram according to an embodiment of the present invention. During T2 period, writing and reading of the peripheral device 200 are performed simultaneously. Further during T1 and T3 periods, only reading is performed. However, data accessing of the peripheral device 200 is not limited to the embodiment of FIG. 4D.

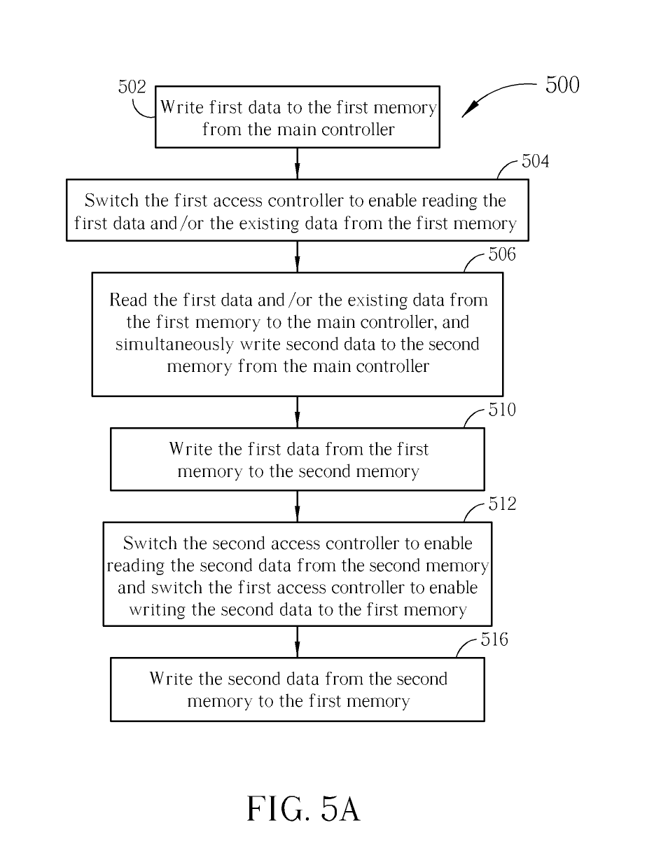

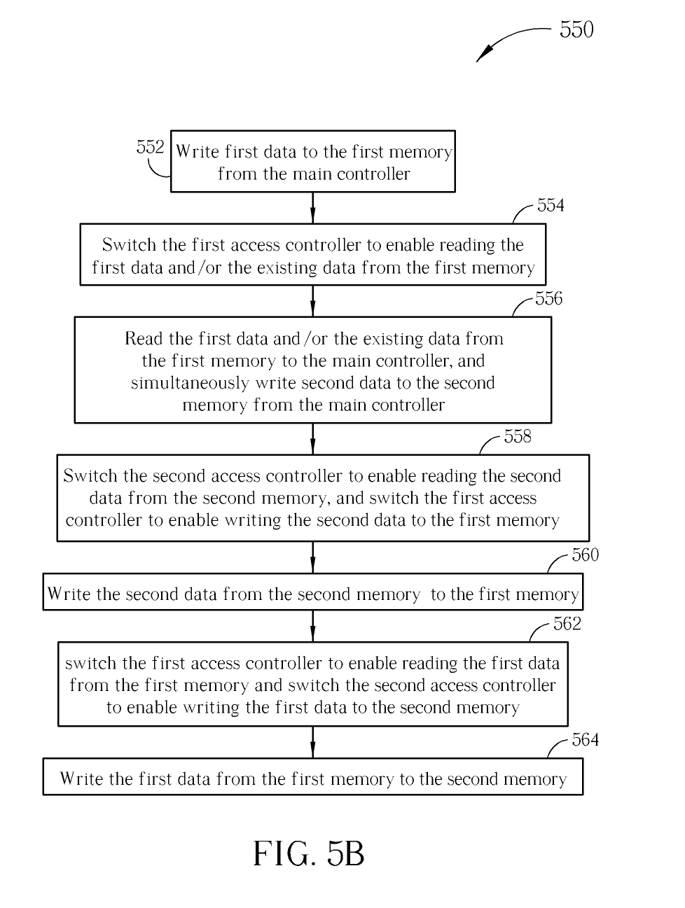

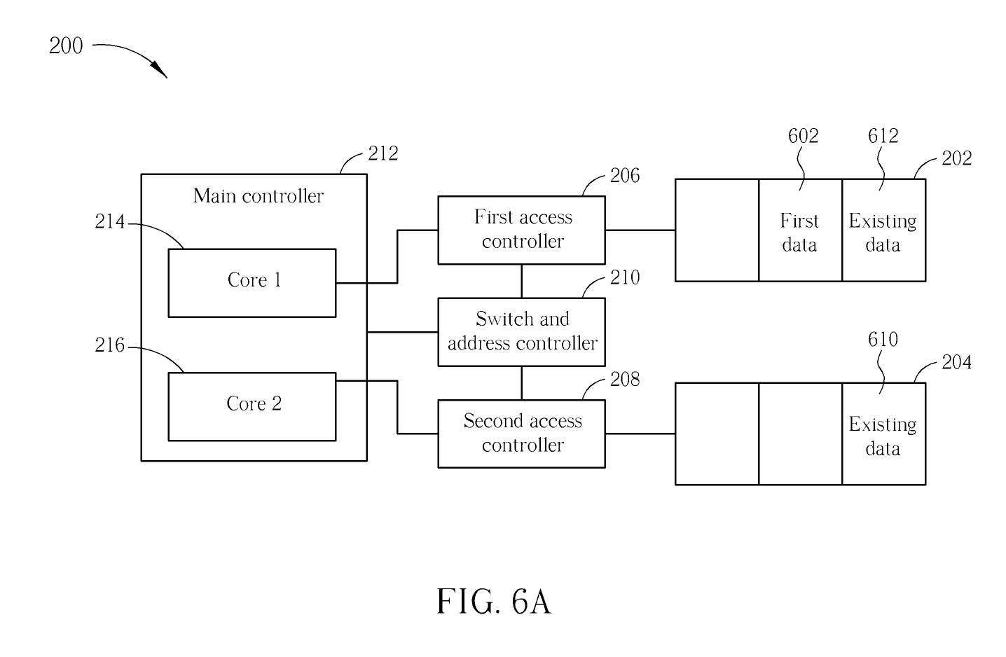

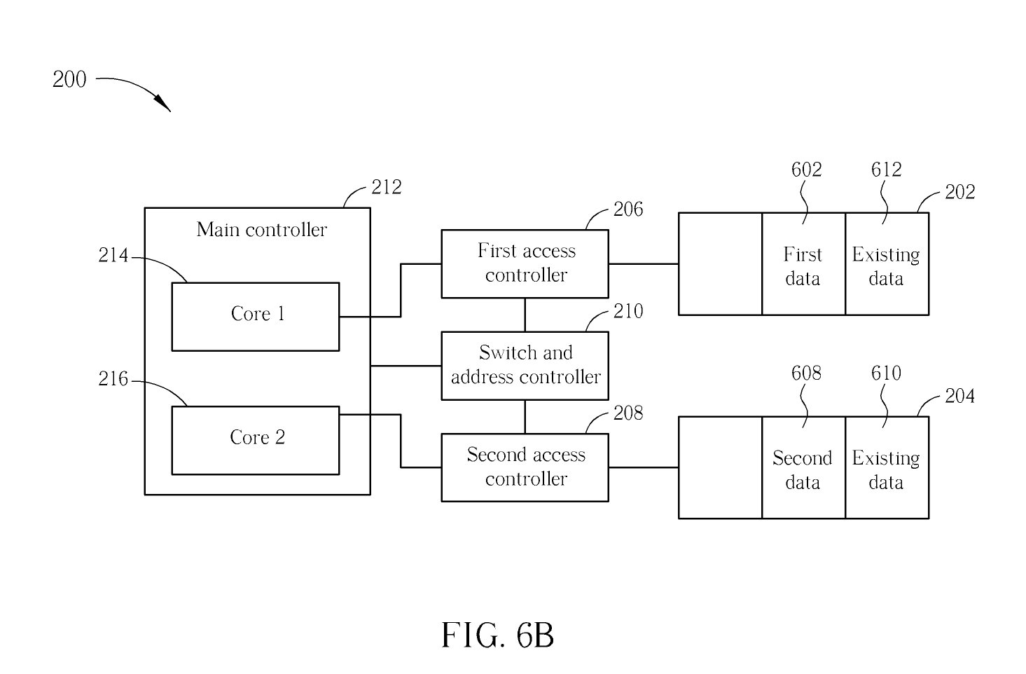

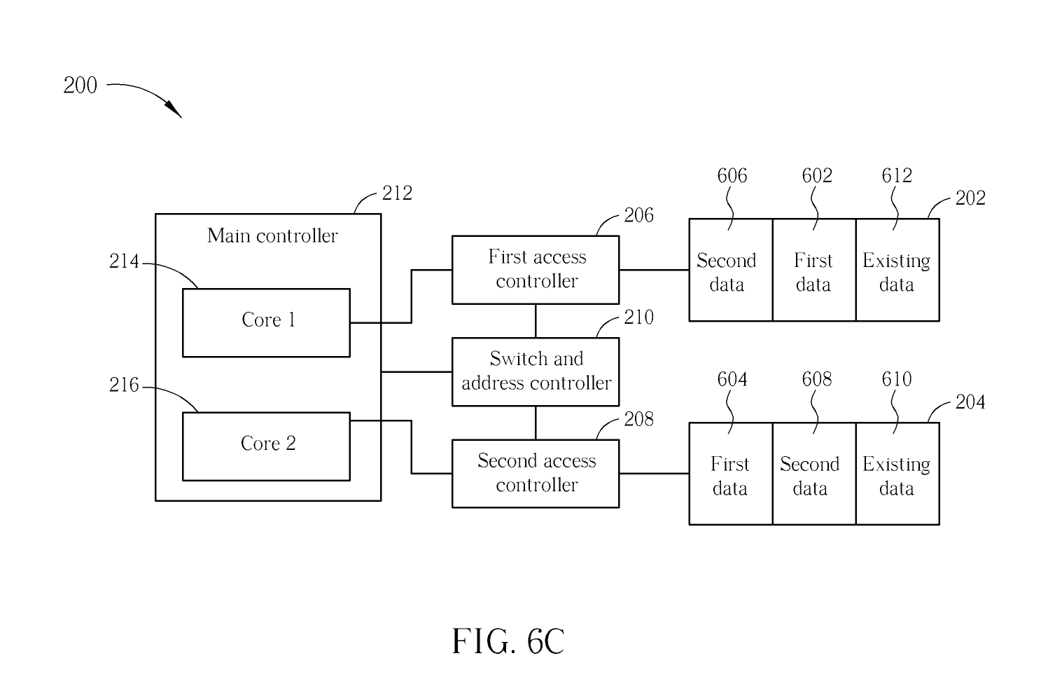

Please refer to FIG. 5A, 5B, 6A, 6B, and 6C. FIG. 5A, 5B are flowcharts illustrating methods 500, 550 for controlling data access of the peripheral device 200 according to other embodiments of the present invention. FIG. 6A is a preliminary status of the peripheral device 200 in the method 500. The peripheral device 200 includes first data 602 and existing data 612 in the first memory 202 and existing data 610 in the second memory 204. The existing data 612 and the existing data 610 are identical. The method 500 is illustrated as follows:

Step 502: write first data 602 to the first memory 202 from the main controller 212;

Step 504: switch the first access controller 206 to enable reading the first data 602 and/or the existing data 612 from the first memory 202;

Step 506: read the first data 602 and/or the existing data 612 from the first memory 202 to the main controller 212, and simultaneously write second data 608 to the second memory 204 from the main controller 212;

Step 510: write the first data 602 from the first memory 202 to the second memory 204;

Step 512: switch the second access controller 208 to enable reading the second data 608 from the second memory 204 and switch the first access controller 206 to enable writing the second data 608 to the first memory 202;

Step 516: write the second data 608 from the second memory 204 to the first memory 202.

The first access controller 206 and the second access controller 208 can be switched to enable reading data to the main controller 212, or writing data to the first memory 202 and the second memory 204 by the switch and address controller 210. And the switching process can be performed before step 502 or in between step 506 to step 516. Further in step 510, the switch and address controller 210 can be switched to enable passing the first data 602 through the switch and address controller 210 so that writing the first data 602 from the first memory 202 to the second memory 204 can be through the first access controller 206, the switch and address controller 210, and the second access controller 208. In another embodiment, the main controller 212 can be switched to enable passing the first data 602 through the main controller 212 so that writing the first data 602 from the first memory 202 to the second memory 204 can be through the first access controller 206, the main controller 212, and the second access controller 208. Similarly, in step 516, the switch and address controller 210 can be switched to enable passing the second data 608 through the switch and address controller 210 so that writing the second data 608 from the second memory 204 to the first memory 202 can be through the second access controller 208, the switch and address controller 210, and the first access controller 206. In another embodiment, the main controller 212 can be switched to enable passing the second data 608 through the main controller 212 so that writing the second data 608 from the second memory 204 to the first memory 202 can be through the second access controller 208, the main controller 212, and the first access controller 206.

The first data 602 in the first memory 202 is written to the second memory 204 as in step 510 to clone and backup the first data 602 in the first memory 202 to the second memory 204 as the first data 604 of FIG. 6C. The second data 608 in the second memory 204 is written to the first memory 202 as in step 516 to clone and backup the second data 608 in the second memory 204 to the first memory 202 as the second data 606 of FIG. 6C.

Since there are two memories in the peripheral device 200, when reading the first data 602 and/or the existing data 612 from the first memory 202 to the main controller 212, the second data 608 can be written to the second memory 204 from the main controller 212 at the same time. Thus, writing and reading of the peripheral device 200 can be performed simultaneously so as to work in full duplex mode to improve data transfer rate.

In another embodiment of the present invention, step 510 can be performed after steps 512, 516. If step 510 is performed after steps 512, 516, the second access controller 208 has to be switched to enable writing and the first access controller 206 has to be switched to enable reading before performing step 510 because the second access controller 208 was switched to enable reading and the first access controller 206 was switched to enable writing in step 512. The method 550, as showed in FIG. 5B, is illustrated as follows:

Step 552: write first data 602 to the first memory 202 from the main controller 212;

Step 554: switch the first access controller 206 to enable reading the first data 602 and/or the existing data 612 from the first memory 202;

Step 556: read the first data 602 and/or the existing data 612 from the first memory 202 to the main controller 212, and simultaneously write second data 608 to the second memory 204 from the main controller 212;

Step 558: switch the second access controller 208 to enable reading the second data 608 from the second memory 204, and switch the first access controller 206 to enable writing the second data 608 to the first memory 202;

Step 560: write the second data 608 from the second memory 204 to the first memory 202;

Step 562: switch the first access controller 206 to enable reading the first data 602 from the first memory 202 and switch the second access controller 208 to enable writing the first data 602 to the second memory 204;

Step 564: write the first data 602 from the first memory 202 to the second memory 204.

In another embodiment, the main controller 212 checks whether the existing data 612 in the first memory 202 is being read before performing step 502, if so, the first data 602 is written to the second memory 204 simultaneously as the existing data 612 is being read. After reading the existing data 612 and writing the first data 602 are completed, the main controller 212 checks whether the first data 602 and/or the existing data 610 in the second memory 204 is being read, if so, the second data 608 can be written to the first memory 202 simultaneously as the first data 602 and/or the existing data 610 is being read. After reading the first data 602 and/or the existing data 610 and writing the second data 608 are completed, the first data 602 in the second memory 204 and the second data 608 in the first memory 202 are synchronized between the first memory 202 and the second memory 204 so that identical copies of both the first data 602 and the second data 608 may exist both in the first memory 202 and the second memory 204.

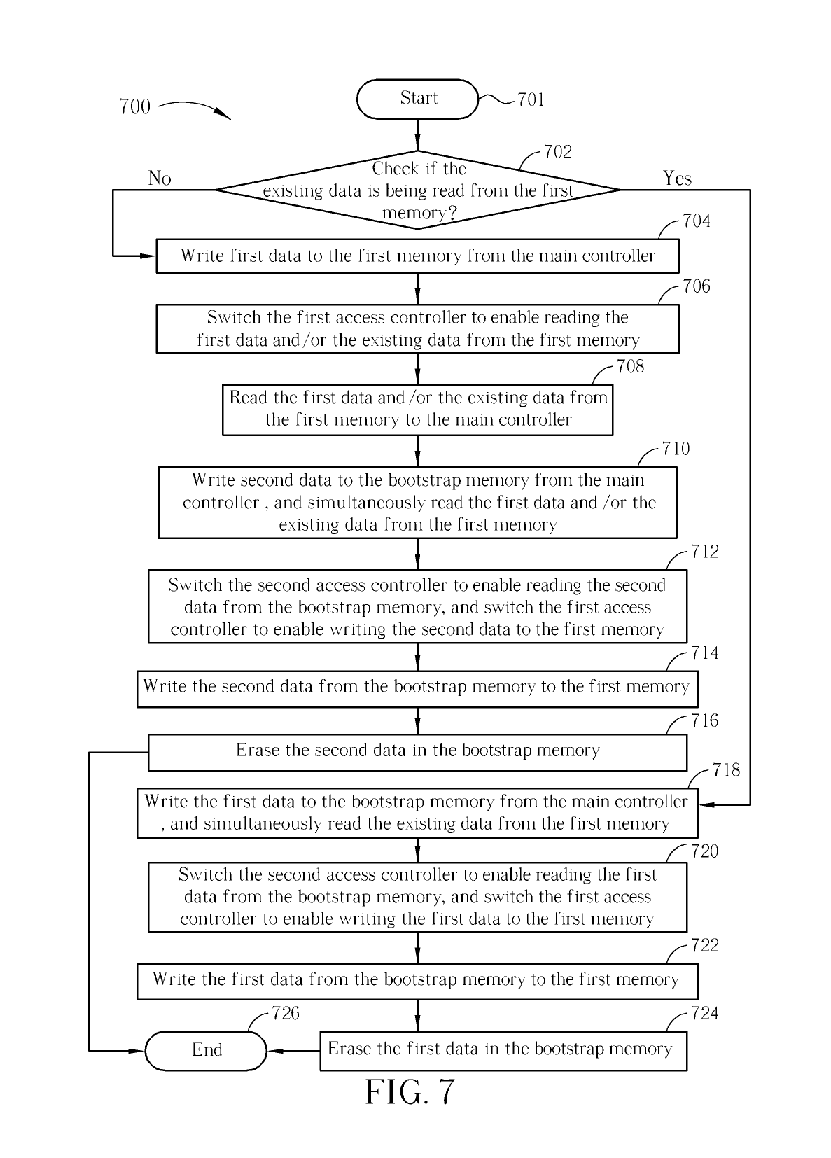

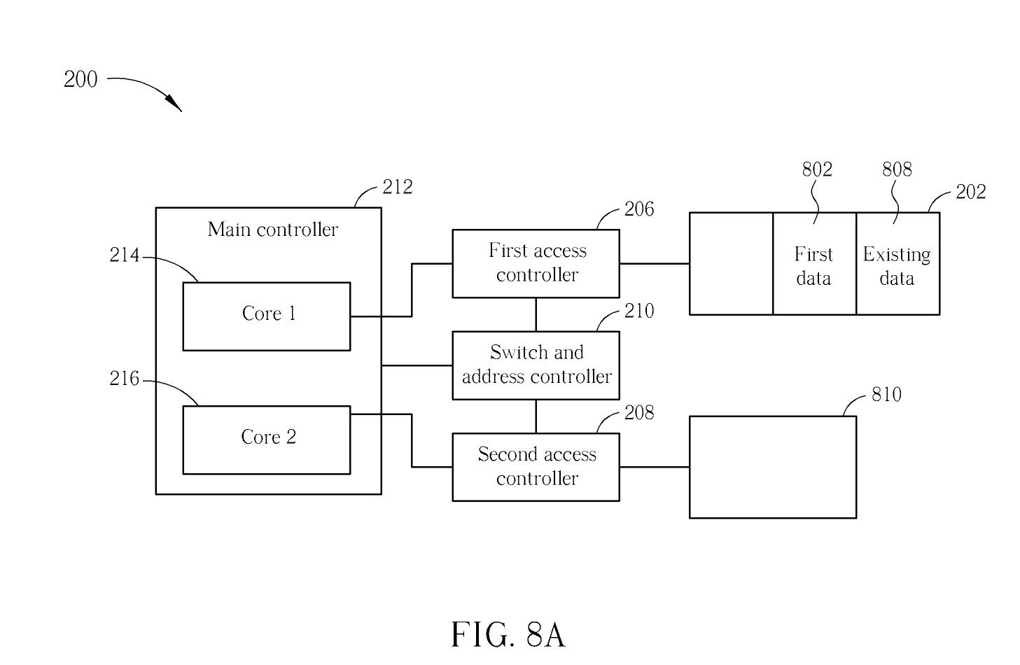

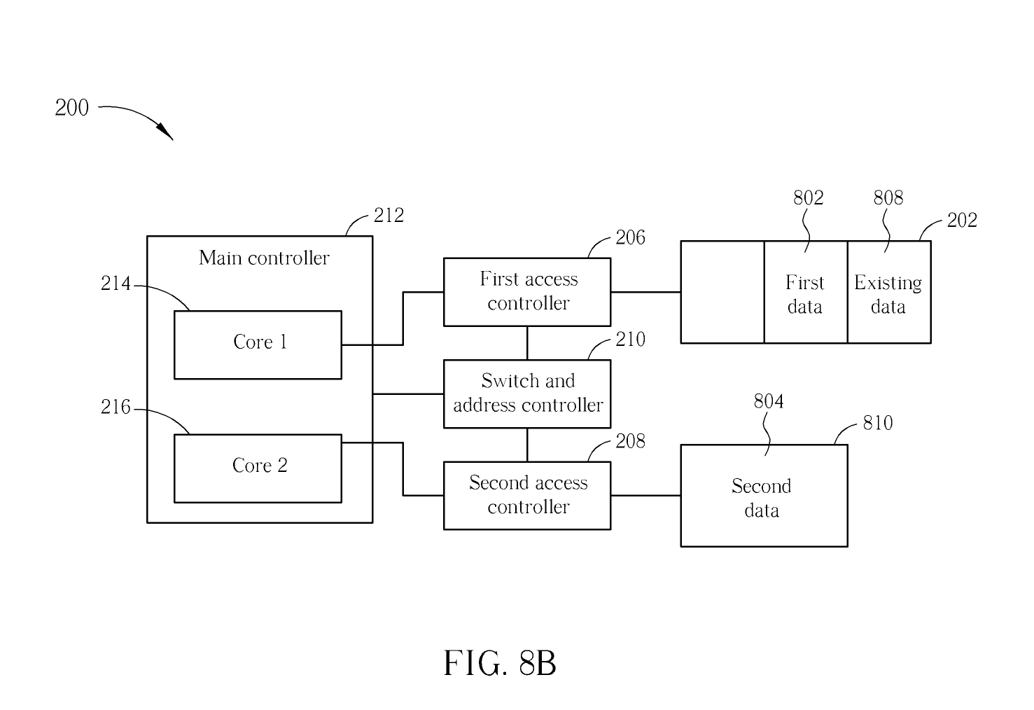

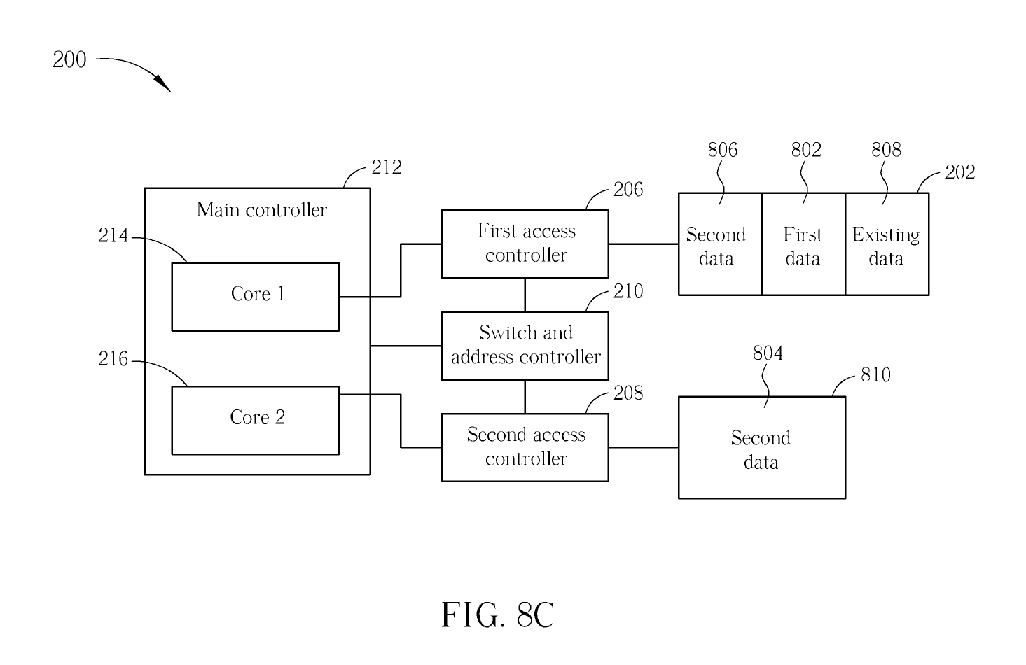

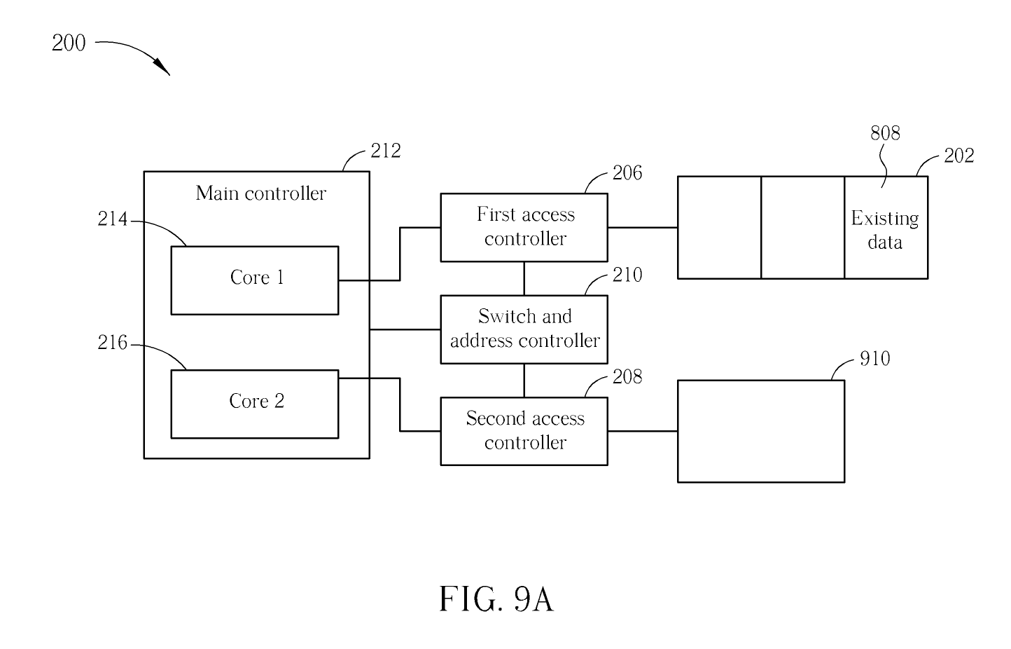

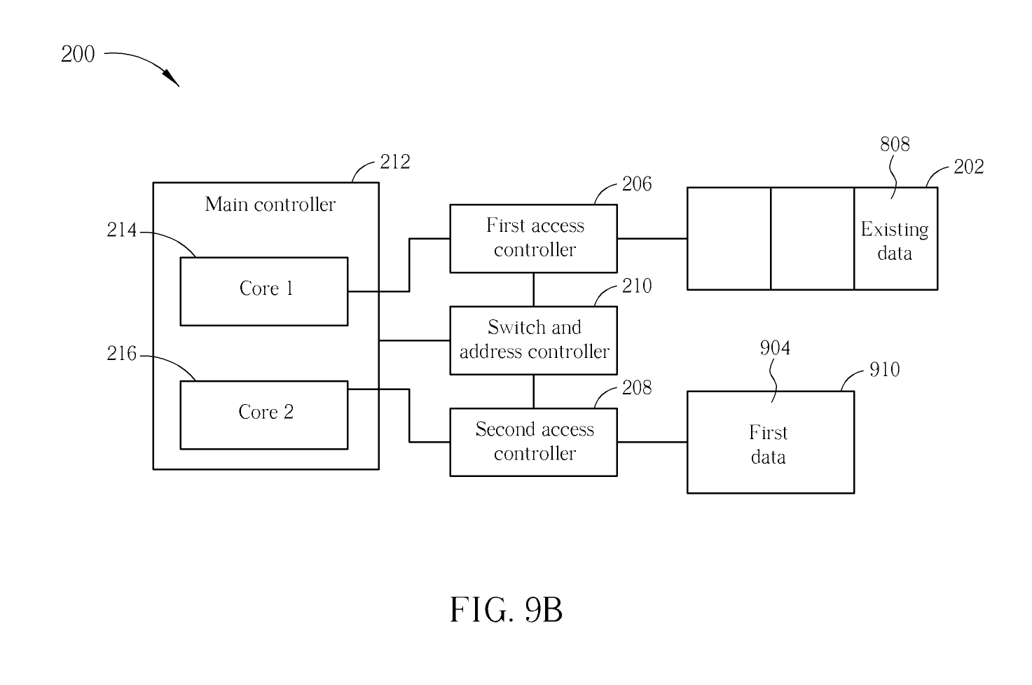

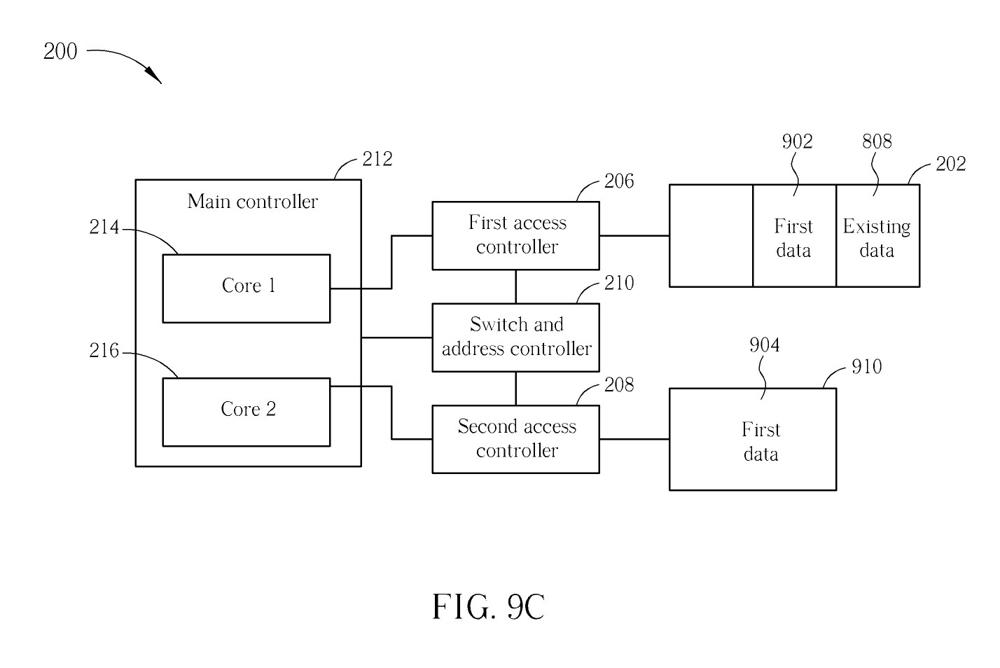

Please refer to FIGS. 7, 8A, 8B, 8C, 9A, 9B, and 9C. FIG. 7 is a flow chart illustrating a method 700 for controlling data access of the peripheral device 200 according to another embodiment of the present invention. FIG. 8A is a preliminary status of the peripheral device 200 in the method 700. The peripheral device 200 includes the first memory 202 and a bootstrap memory 810. The capacity of the bootstrap memory 810 can be smaller than the first memory 202. FIG. 9A is a preliminary status of the peripheral device 200 in the method 700. The capacity of the bootstrap memory 910 can be smaller than the first memory 202. Existing data 808 was stored in the first memory 202 before the method 700 starts.

The bootstrap memory 810 and the bootstrap memory 910 can function as a writing buffer, that is, if the existing data 808 is being read from the first memory 202 to the main controller 212, the first data 904 from the main controller 212 is written to the bootstrap memory 910 for temporary storage waiting to be transferred later the first memory 202, as showed in FIG. 9A to 9C. If the existing data 808 is not being read from the first memory 202 to the main controller 212, first data 802 from the main controller 212 is written to the first memory 202 directly with no need to access the bootstrap memory 810 or 910, as showed in FIG. 8A. The method 700 is illustrated as follows:

Step 701: start;

Step 702: check if the existing data 808 is being read from the first memory 202; if so, perform Step 718; if not, perform Step 704;

Step 704: write first data 802 to the first memory 202 from the main controller 212;

Step 706: switch the first access controller 206 to enable reading the first data 802 and/or the existing data 808 from the first memory 202;

Step 708: read the first data 802 and/or the existing data 808 from the first memory 202 to the main controller 212;

Step 710: write second data 804 to the bootstrap memory 810 from the main controller 212, and simultaneously read the first data 802 and/or the existing data 808 from the first memory 202;

Step 712: switch the second access controller 208 to enable reading the second data 804 from the bootstrap memory 810, and switch the first access controller 206 to enable writing the second data 804 to the first memory 202;

Step 714: write the second data 804 from the bootstrap memory 810 to the first memory 202;

Step 716: erase the second data 804 in the bootstrap memory 810; go to step 726;

Step 718: write the first data 904 to the bootstrap memory 910 from the main controller 212, and simultaneously read the existing data 808 from the first memory 202;

Step 720: switch the second access controller 208 to enable reading the first data 904 from the bootstrap memory 910, and switch the first access controller 206 to enable writing the first data 904 to the first memory 202;

Step 722: write the first data 904 from the bootstrap memory 910 to the first memory 202;

Step 724: erase the first data 904 in the bootstrap memory 910;

Step 726: end.

The first access controller 206 and the second access controller 208 can be switched to enable reading data to the main controller 212, or writing data to the first memory 202 and the second memory 204 by the switch and address controller 210. And the switching process can be performed before step 704 or in between step 706 to step 726. In another embodiment, the main controller 212 can be switched to enable passing the second data 804 through the main controller 212 so that writing the second data 804 from the bootstrap memory 810 to the first memory 202 can be through the second access controller 208, the main controller 212, and the first access controller 206.

In another embodiment, step 716 of the method 700 can be omitted. In this case the second data 804 is left in the bootstrap memory 810 and is overwritten when a next piece of data is written to the bootstrap memory 810.

In still another embodiment, step 716 of the method 700 can be omitted and step 714 can be replaced with:” move the second data 804 from the bootstrap memory 810 to the first memory 202.” After the second data 804 is moved from the bootstrap memory 810 to the first memory 202, the bootstrap memory 810 is cleared and the second data 804 is transferred to the memory 202.

When reading the first data 802 from the first memory 202 to the main controller 212, the second data 804 can be written to the bootstrap memory 810 at the same time. Thus writing and reading of the peripheral device 200 can be performed simultaneously so as to work in full duplex mode to improve data transfer rate.

In step 722, the first data 904 in the bootstrap memory 910 can be transfer through the same data path as in step 714. Step 724 can be omitted in another embodiment. Step 722 can be replaced with: “move the first data 904 from the bootstrap memory 910 to the first memory 202.”

The present invention provides a peripheral device including two memories with two access controllers, and both access controllers are connected to a main controller. When accessing data, a piece of data is written to any of the two memories from the main controller while another piece of data is read from the other one memory to the main controller. Then clone or synchronize the data between the two memories. Therefore the two memories will always have the identical data content, and the process of data writing and reading can be performed simultaneously in the peripheral device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A peripheral device comprising:
a first memory;
a first access controller coupled to the first memory for accessing the first memory;
a second memory;
a second access controller coupled to the second memory for accessing the second memory;
a switch and address controller coupled to the first access controller and the second access controller for switching the first access controller and the second access controller and recording addresses of data stored in the first memory and the second memory; and
a main controller coupled to the switch and address controller, the main controller comprising:
a first core coupled to the first access controller for controlling data access of the first access controller; and
a second core coupled to the second access controller for controlling data access of the second access controller;
wherein both the first memory and the second memory store identical data.

2. The peripheral device of claim 1, wherein the first and second memories are non-volatile memories.

3. The peripheral device of claim 1, wherein the second memory is a bootstrap memory.

4. The peripheral device of claim 1, wherein the switch and address controller is integrated into the main controller.

5. The peripheral device of claim 4, wherein the first access controller and the second access controller are integrated into the main controller.

6. A method for controlling data access of a peripheral device, the peripheral device comprising a first memory and a second memory both storing identical existing data, and a main controller, the method comprising steps of:
(a) writing first data to the first memory from the main controller;
(b) reading the existing data from the second memory to the main controller when writing the first data to the first memory;
(c) reading the first data from the first memory by a first access controller coupled to the main controller and the first memory; and
(d) writing the first data to the second memory by a second access controller coupled to the main controller and the second memory;
wherein the first access controller and the second access controller are controlled by a switch and address controller.

7. The method of claim 6, wherein the switch and address controller is integrated into the main controller.

8. The method of claim 6, wherein the first data written from the first memory to the second memory is through the switch and address controller.

9. The method of claim 6, wherein the first data written from the first memory to the second memory is through the main controller.

10. The method of claim 7, wherein the first access controller and the second access controller are integrated into the main controller.

11. A method for controlling data access of a peripheral device, the peripheral device comprising a first memory and a second memory both storing identical existing data, and a main controller, the method comprising steps of:
(a) writing first data to the first memory from the main controller;
(b) reading the first data and/or the existing data from the first memory to the main controller;
(c) writing second data to the second memory from the main controller when reading the first data and/or the existing data from the first memory;
(d) reading the first data from the first memory by a first access controller;
(e) writing the first data to the second memory by a second access controller;
(f) reading the second data from the second memory by the second access controller; and
(g) writing the second data to the first memory by the first access controller;
wherein the first access controller and the second access controller are controlled by a switch and address controller.

12. The method of claim 11, wherein the switch and address controller is integrated into the main controller.

13. The method of claim 11, wherein the first data written from the first memory to the second memory is through the switch and address controller.

14. The method of claim 13, wherein the second data written from the second memory to the first memory is through the switch and address controller.

15. The method of claim 11, wherein the first data written from the first memory to the second memory is through the main controller.

16. The method of claim 15, wherein the second data written from the second memory to the first memory is through the main controller.

17. The method of claim 12, wherein the first access controller and the second access controller are integrated into the main controller.

18. A method for controlling data access of a peripheral device, the peripheral device comprising a memory storing existing data, a bootstrap memory and a main controller, the method comprising steps of:
(a) checking whether the existing data is being read by the main controller;
(b) writing data to the bootstrap memory if the existing data is being read by the main controller; and
(c) writing the data to the memory if the existing data is not being read by the main controller.

19. The method of claim 18, after the step of writing the data to the bootstrap memory, the method further comprising:
(d) moving the data from the bootstrap memory to the memory.

20. The method of claim 19, wherein the step of (d) comprises steps of:
(d-1) reading the data from the bootstrap memory by a second access controller;
(d-2) writing the data to the memory by a first access controller; and
(d-3) erase the data stored in the bootstrap memory;
wherein the first access controller and the second access controller are controlled by a switch and address controller.

21. The method of claim 20, wherein the switch and address controller is integrated into the main controller.

22. The method of claim 21, wherein the first access controller and the second access controller are integrated into the main controller.

23. The method of claim 20, wherein the data written from the bootstrap memory to the memory is through the switch and address controller.

24. The method of claim 20, wherein the data written from the bootstrap memory to the memory is through the main controller.

25. A method for controlling data access of a peripheral device, comprising:
reading existing data in a first memory of the peripheral device;
writing first data to a second memory of the peripheral device when reading the existing data in the first memory;
reading the first data from the second memory;
writing second data to the first memory when reading the first data in the second memory; and
synchronizing the first data and the second data in the first memory and the second memory after steps of reading the first data from the second memory and writing the second data to the first memory are completed.
